(19) United States
(12) Patent Application Publication
(10) Pub. No.: US 2025/0045592 A1
(43) Pub. Date: Feb. 6, 2025

(54) EDGE DATA GATHERING USING REINFORCEMENT LEARNING AND DISTRIBUTION CLIQUES

(71) Applicant: EMC IP Holding Company LLC, Hopkinton, MA (US)

(72) Inventors: Pablo Nascimento Da Silva, Niterói (BR); Paulo Abelha Ferreira, Rio de Janeiro (BR); Vinicius Michel Gottin, Rio de Janeiro (BR)

(73) Assignee: EMC IP Holding Company LLC, Hopkinton, MA (US)

(21) Appl. No.: 18/230,029

(22) Filed: Aug. 3, 2023

(51) Int. Cl. G06N 3/092; G06N 3/047

(52) U.S. Cl. CPC G06N 3/092; G06N 3/047

(57) ABSTRACT

Techniques are disclosed for edge node data gathering. One example method includes receiving probability distributions from edge nodes; using the probability distributions to identify a set of distribution cliques of the edge nodes; selecting one or more representative edge nodes from each clique; receiving feature data from the edge nodes, the feature data comprising resource information that includes a resource availability and a utilization status of the edge node at a first time, t−1; training a ML-based model using a portion of the feature data; associating the feature data with the corresponding clique for the edge node at the first time; using the probability distributions, cliques, and feature data to obtain episode data for each clique for the first time; and training a ML-based divergence model using a portion of the episode data to update a divergence threshold value for the clique for a second time, t.

### FIELD

Example embodiments generally relate to machine learning model management in edge networks. More specifically, at least some embodiments relate to systems, hardware, software, computer-readable media, and methods for managing machine learning models for nodes in an edge environment.

### BACKGROUND

The emergence of edge computing highlights benefits of machine learning (ML) model management at the edge. Enterprises are interested in edge solutions and end-to-end commercial portfolios that offer smarter and safer ML. It is desirable to train and periodically update a central ML model that is to be used for inference of data coming from different edge nodes. In particular, enterprises and other customers seek to maximize the model's quality while minimizing the computational overhead imposed over the associated edge nodes for obtaining and transmitting the data.

### BRIEF SUMMARY

In one embodiment, a system includes at least one processing device including a processor coupled to a memory. The at least one processing device can be configured to implement the following steps: receiving a plurality of probability distributions from a plurality of edge nodes; using the probability distributions to identify a set of distribution cliques of the edge nodes; selecting one or more representative edge nodes from each clique; receiving feature data from the edge nodes, the feature data comprising resource information that includes a resource availability and a utilization status of the edge node at a first time t−1; training a machine learning (ML)-based model using a portion of the feature data; associating the feature data with the corresponding clique for the edge node at the first time; using the probability distributions, cliques, and feature data to obtain episode data for each clique for the first time; and training a ML-based divergence model using a portion of the episode data to update a divergence threshold value for the clique for a second time, t, that is different from the first time.

In some embodiments, the divergence threshold value is updated based on an average of divergence metrics output by the divergence model after the divergence model is deployed in an edge network that includes the plurality of edge nodes. A number of cliques can be updated for a future training cycle of the ML model. The divergence model can comprise a deep Q-learning reinforcement learning model. The reinforcement learning model can be trained using a graph neural network. The cliques can comprise graphs, the probability distributions and the feature data can comprise metadata annotated to nodes of the graphs, and the annotated graphs can be used as input to the graph neural network. The episode data for the second time, t, can be obtained without considering the clique for the second time. The representative edge nodes can be selected at random from each clique. The cliques can be identified using an identification algorithm comprising: calculating a divergence value between two edge nodes of the plurality of edge nodes; comparing the divergence value with the divergence threshold value to obtain a result; and using the result to determine that the two edge nodes are in a clique.

Other example embodiments include, without limitation, apparatus, systems, methods, and computer program products comprising processor-readable storage media.

Other aspects of the invention will be apparent from the following description and the appended claims.

### BRIEF DESCRIPTION OF THE SEVERAL VIEWS OF THE DRAWINGS

The foregoing summary, as well as the following detailed description of exemplary embodiments of the invention, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIGS. 1A and 1B illustrate aspects of an example edge computing environment, in accordance with illustrative embodiments.

FIG. 2 illustrates a flowchart of an example method for determining a divergence threshold during data gathering, in accordance with illustrative embodiments.

FIGS. 3 and 4 illustrate aspects of example distribution cliques of edge nodes, in accordance with illustrative embodiments.

FIG. 5 illustrates a flowchart of an example method for determining a divergence threshold during data gathering, in accordance with illustrative embodiments.

FIGS. 6 and 7 illustrate aspects of example data gathering from edge nodes, in accordance with illustrative embodiments.

FIGS. 8A and 8B illustrate aspects of example episode composition, in accordance with illustrative embodiments.

FIG. 9 illustrates aspects of example bootstrapping during a training stage, in accordance with illustrative embodiments.

FIG. 10 illustrates aspects of determining a divergence threshold during a deployment stage, in accordance with illustrative embodiments.

FIG. 11 illustrates a flowchart of an example method for determining a divergence threshold, in accordance with illustrative embodiments.

FIG. 12 illustrates aspects of an example computing entity configured and operable to perform any of the disclosed methods, algorithms, processes, steps, and operations, in accordance with illustrative embodiments.

### DETAILED DESCRIPTION

Example embodiments generally relate to machine learning model management in edge networks. More specifically, at least some embodiments relate to systems, hardware, software, computer-readable media, and methods for managing machine learning models for nodes in an edge environment.

Described herein are techniques for improving data gathering for edge nodes by enhancing a method to determine a divergence threshold value that determines node membership in distribution cliques. In example embodiments, the present divergence threshold techniques model the problem of updating the divergence threshold value as a reinforcement learning agent.

The present divergence threshold solution deals with a model management problem in an edge computing environment. Example embodiments of the present divergence threshold techniques enhance a protocol that efficiently manages data from edge nodes for the training of a target network. The present divergence threshold approach provides the following technical solutions, among others:
A contextual determination of cliques for efficient sampling of edge nodes, considering resources at the edge cliques as well as the parametric distributions, and the current cliques
A process to obtain a divergence model that:
   Can deal with varying states including, for example, changes in the cliques, their associated data, and in the number of cliques
   Exploits as much as possible the data gathered in the target model training cycle to compose as many episodes as possible to bootstrap the policy network;
   With an optional intermediate bootstrap phase that further exploits a tradeoff between generalization and correctness of the divergence model, with a stopping criteria based on the loss of correctness; and
A continuous process to adapt the policy network as new episodes are made available.

### A. GENERAL ASPECTS OF AN EXAMPLE EMBODIMENT

### A. 1. Introduction

Described herein is an example ML training scenario in a distributed environment. The present divergence threshold techniques leverage a protocol for minimizing the amount of data sent from the edge nodes to the central node while keeping a high accuracy of the common model. That protocol is dependent on a divergence threshold value (sometimes also referred to herein as a “divergence threshold parameter”). In existing data gathering systems, the divergence threshold value is difficult to keep updated since it is updated using a blind stepwise method.

In example embodiments, the present divergence threshold techniques leverage a method to update the similarity-based divergence threshold value by modelling the problem of updating the divergence threshold value as a reinforcement learning agent.

### A.2. Overview

Enterprises are strongly interested in leveraging smarter and safer ML at the edge using edge solutions and end-to-end commercial portfolios such as those offered by Dell Technologies in Round Rock, Texas, United States. In particular, a technical problem exists to train and periodically update a central ML model that is to be used for inference of data coming from different edge nodes. The present divergence threshold techniques address the technical problem of maximizing the model's quality while also minimizing the computational overhead imposed over the edge nodes for obtaining and transmitting the data.

Sizing of storage arrays is one example use case where data gathering is important. Sizing is a crucial step when defining an appropriate infrastructure to support customers' needs. However, sizing is often done without knowing exactly whether the sized infrastructure will satisfy response-time and other service level requirements of the end user's applications.

Example embodiments of the present divergence threshold techniques leverage the availability of telemetry data from different system configurations and use ML to model the relationship between configuration parameters (e.g., storage model, number of flash or spin disks, number of engines, and the like), characteristics of the workloads running on those systems (e.g., number of cache read/write hits/misses, size of reads/writes in MB, and the like), and measured response times. By doing this, it is expected for ML techniques to be able to predict read and write response times of a specific system configuration for a particular workload without having to run the workload on the sized system. As a result, customers can have an immediate estimate of response times of the system they are evaluating, while the business can potentially reduce operational costs associated with system performance evaluations.

### A.3. Technical Problems

To leverage data coming from edge nodes (such as, for example, storage arrays) in order to train a central ML model, (partial or complete) access to the data coming from each storage array is needed. More particularly, the more available data, the higher an expectation over the central model's prediction quality. However, more data generally requires more network traffic. This is a classic tension in distributed learning settings. Furthermore, there might be processing costs associated with the data collection and/or preparation processes before the data can be transmitted to the central node.

Although ML techniques such as Federated Learning tackle the problem of data privacy at the edge by communicating model gradients, performing Federated Learning in non-independent and identically distributed (i.i.d.) data settings remains an open research problem. Advantageously, the present divergence threshold solution is not limited to i.i.d. data since there is less of a direct focus on data privacy by, for example, performing Federated Learning.

Moreover, even techniques such as Federated Learning do not necessarily solve the problem of choosing which nodes to sample information (e.g., gradients) from. It is appreciated that the present divergence threshold solution can be extended to deal with ML techniques such as Federated Learning by adapting the distributions over data to be over gradients, instead.

### B. CONTEXT FOR AN EXAMPLE EMBODIMENT

### B.1. Divergence Threshold System

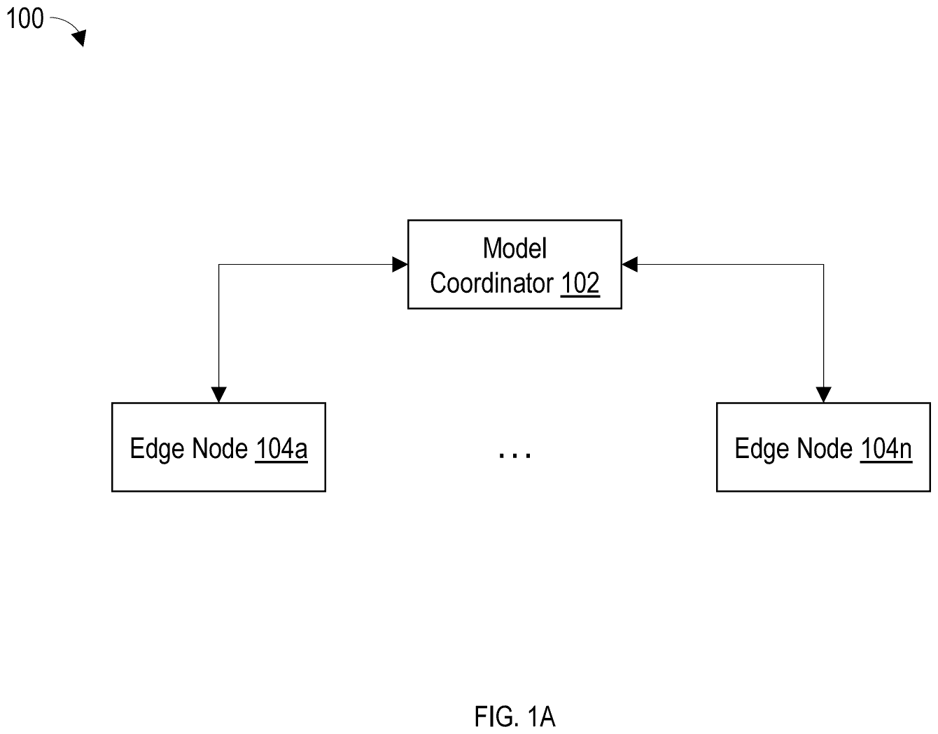

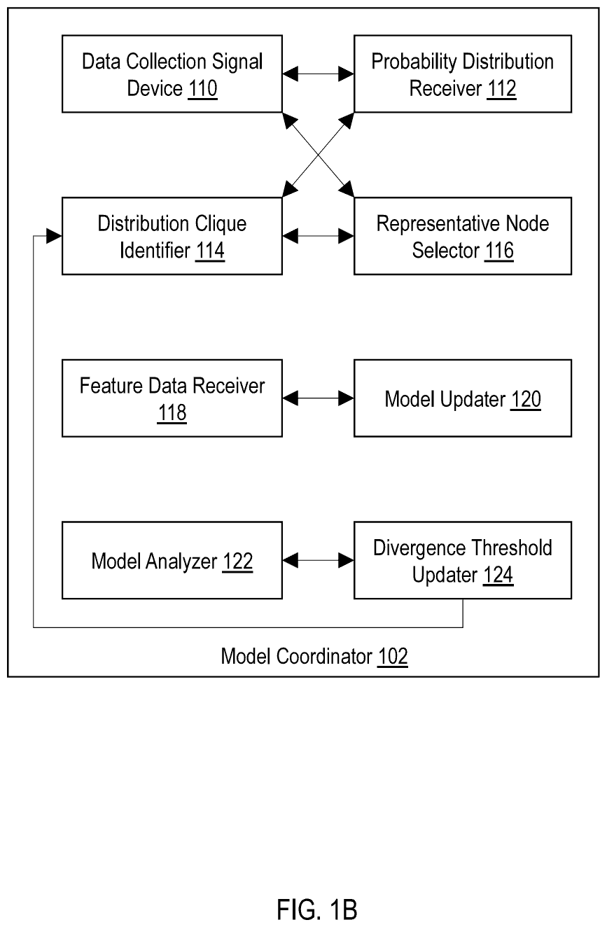

FIG. 1A shows a diagram of an example system in accordance with illustrative embodiments. The system 100 includes a model coordinator 102 operatively connected to any number of edge nodes (e.g., edge node A 104a, edge node N 104n). Each of these components is described below.

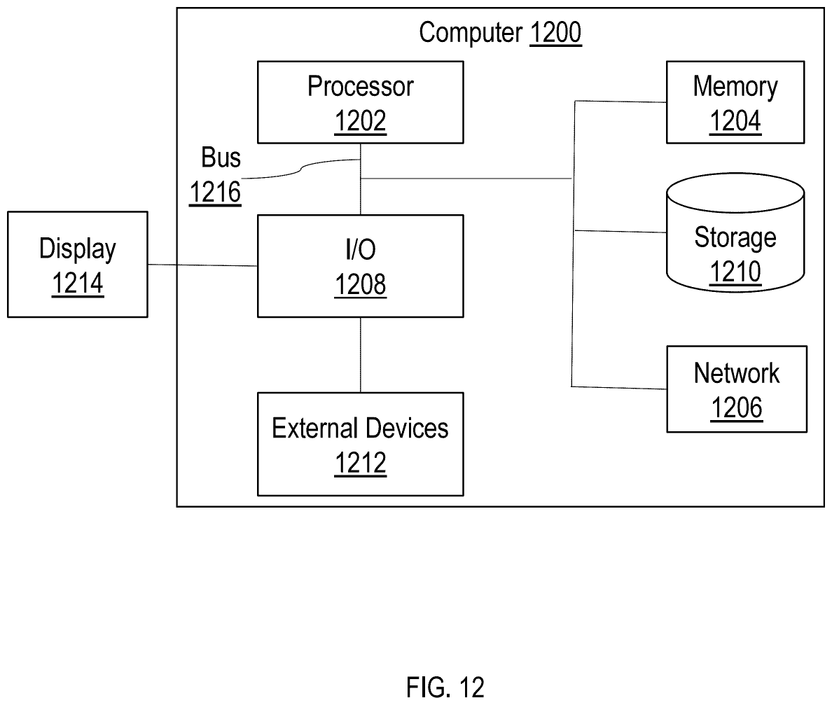

In example embodiments the edge nodes 104a, . . . , 104n (collectively, 104) may be computing devices, which components are described in further detail in connection with FIG. 12. As used herein, an edge node 104 refers to any computing device, collection of computing devices, portion of one or more computing devices, or any other logical grouping of computing resources.

In example embodiments an edge node 104 includes functionality to generate or otherwise obtain any amount or type of telemetry feature data that is related to the operation of the edge device. As used herein, a feature refers to any aspect of an edge device for which telemetry data may be recorded over time. For example, a storage array edge device may include functionality to obtain feature data related to data storage, such as read response time, write response time, number and/or type of disks (e.g., solid state, spinning disks, etc.), model number(s), number of storage engines, cache read/writes and/or hits/misses, size of reads/writes in megabytes, and the like.

In example embodiments an edge node 104 includes enough computational resources to use such telemetry feature data to calculate probability distributions for any or all features. A probability distribution refers to a mathematical function that describes the probabilities that a variable will have values within a given range. A probability distribution may be represented, by way of non-limiting example, by probability distribution characteristics such as mean and variance.

The model coordinator 102 is operatively connected to the edge nodes 104. A model coordinator may be separate from and connected to any number of edge nodes. The model coordinator and associated components are discussed further in the description of FIG. 1B. The model coordinator is a computing device, which components are further described in connection with FIG. 12.

In example embodiments, the edge nodes 104 and the model coordinator 102 are operatively connected via a network. A network may refer to an entire network or any portion thereof (e.g., a logical portion of the devices within a topology of devices). A network may include a datacenter network, a wide area network, a local area network, a wireless network, a cellular phone network, or any other suitable network that facilitates the exchange of information from one part of the network to another. A network may be located at a single physical location, or be distributed at any number of physical sites. In example embodiments, a network may be coupled with or overlap, at least in part, with the Internet.

While FIG. 1A shows a configuration of components, other configurations may be used without departing from the scope of embodiments described herein. Accordingly, embodiments disclosed herein should not be limited to the precise configuration of components shown in FIG. 1A.

FIG. 1B shows a diagram of an example model coordinator 102 in accordance with illustrative embodiments. The model coordinator may include any number of components. As shown in FIG. 1B, the model coordinator includes a data collection signal device 110, a probability distribution receiver 112, a distribution clique identifier 114, a representative node selector 116, a feature data receiver 118, a model updater 120, a model analyzer 122, and a divergence threshold updater 124. Each of these components is described below.

In example embodiments the model coordinator 102 is a computing device, as discussed above in the description of FIGS. 1A and 12.

In example embodiments the data collection signal device 110 is any hardware (e.g., circuitry), software, firmware, or any combination thereof that includes functionality to transmit signals to one or more edge devices requesting information. In example embodiments, such requests include a request for an edge device to generate and send to the model coordinator 102 one or more probability distributions, each corresponding to one or more features. Such a signal may be referred to as a probability distribution request. In example embodiments, the signal specifies the features for which a probability distribution is requested. In example embodiments, the signal is sent to representative edge nodes selected by the model coordinator, and requests feature data for one or more features from the representative edge nodes. In example embodiments, the probability distribution request signal is sent periodically to the edge nodes. The timing of the probability distribution request signal may be a set interval, or may vary over time. As an example, the probability distribution request signal may be sent daily, or be set at times when the edge nodes are likely to or known to be experiencing a lighter workload, and the like.

In example embodiments, the probability distribution receiver 112 is any hardware (e.g., circuitry), software, firmware, or any combination thereof that includes functionality to obtain/receive probability distributions for one or more features from one or more edge nodes. In example embodiments, probability distributions are received in any manner capable of collecting data from or about computing devices (e.g., via, at least in part, one or more network interfaces of the model coordinator 102.

In example embodiments, the probability distribution receiver 112 has access to a listing of the edge nodes from which one or more probability distributions are to be received, against which it can validate receipt of such probability distributions. In example embodiments probability distributions are received as a set of characteristics of a mathematical function that describes the probability distribution, such as, for example, a mean and a variance for a probability distribution.

In example embodiments, a waiting time is defined for the one or more probability distributions. In example embodiments, if the one or more probability distributions from a given edge node are not received within the waiting time, then the probability distribution receiver 112 may request that the operatively connected data collection signal device 110 re-send the probability distribution request signal to the edge node. Additionally or alternatively, if the one or more requested probability distributions from a given edge node are not received after one or more defined waiting periods, the edge node may be skipped for the current cycle of ML model training.

In example embodiments, the distribution clique identifier 114 is operatively connected to the probability distribution receiver 112. In example embodiments, a distribution clique identifier is any hardware (e.g., circuitry), software, firmware, or any combination thereof that includes functionality to use probability distributions received from one or more edge nodes to identify one or more distribution cliques, each having one or more edge nodes. As used herein, a distribution clique refers to a set of edge devices that are determined to be similar based on an analysis of probability distribution(s) of one or more features.

In example embodiments, such analysis includes determining, for two edge nodes, a divergence value based on the probability distributions, and comparing the divergence value to a divergence threshold value, sometimes referred to herein as ¿. In example embodiments, if the divergence value found between two edge nodes is equal to or below the divergence threshold value, then the nodes are placed in the same distribution clique. If the divergence value for two edge nodes is above the divergence threshold value, then the two edge nodes are not in the same distribution clique. Any method of calculating a divergence value for one or more probability distributions from two edge nodes may be used without departing from the scope of embodiments described herein.

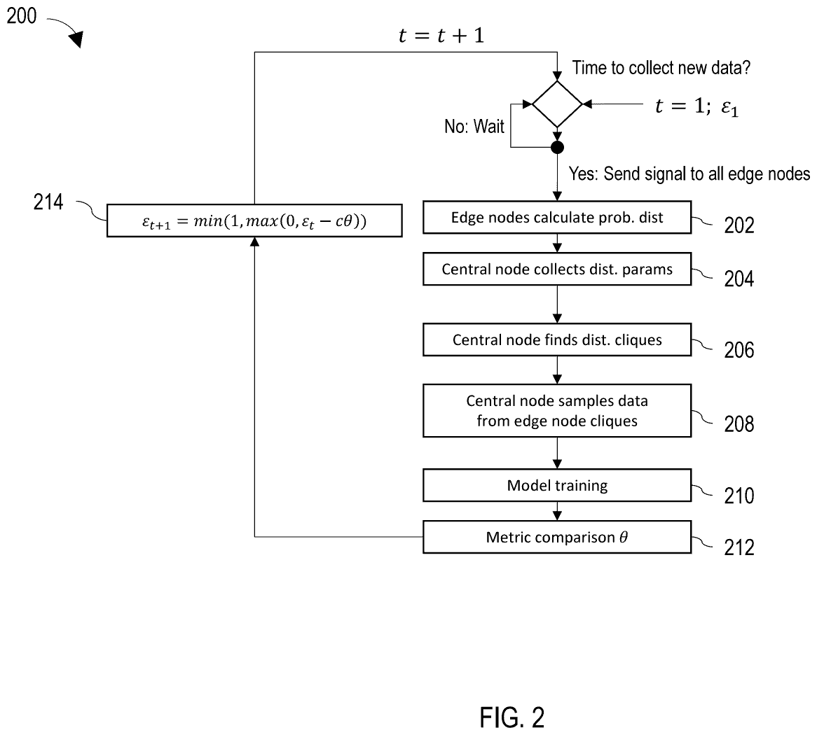

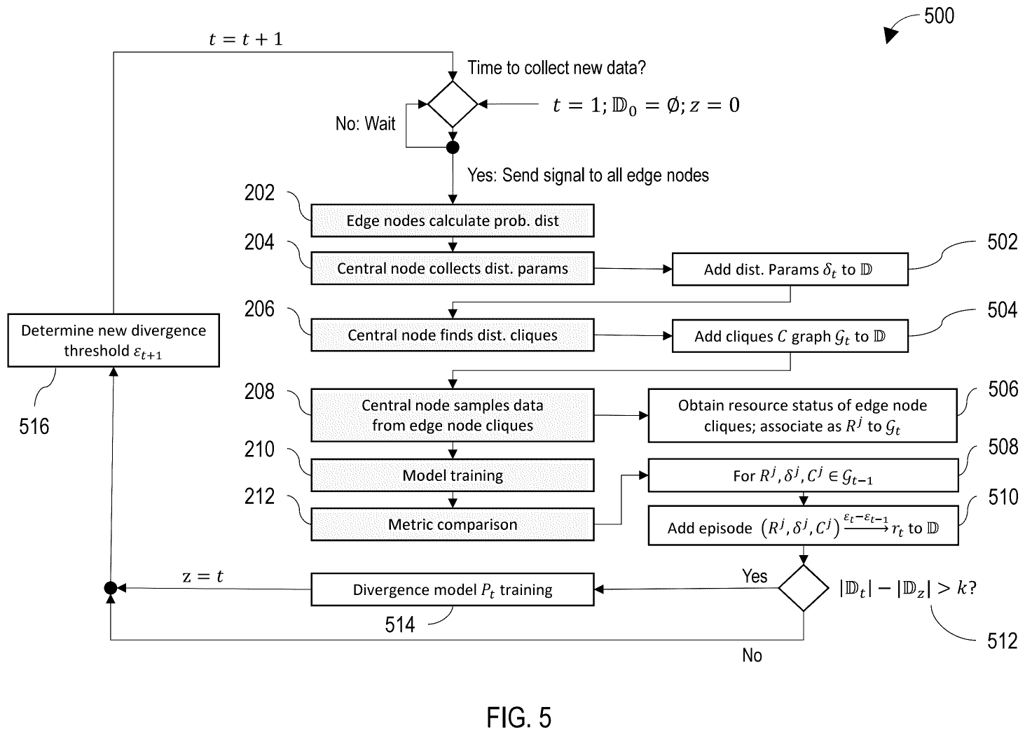

As an example, the distribution clique identifier 114 of the model coordinator 102 may compare edge nodes using a bounded symmetric divergence metric, such as Jensen-Shannon divergence. As another example, the maximal clique identifier may use the square root of the Jensen-Shannon divergence to identify a distance metric, which may be considered a divergence value as used herein. In example embodiments, the final divergence value may be obtained using probability distributions for one or more features, or may be calculated as the average divergence across all features being considered, with such averaging maintaining distance metric properties. Algorithms for identifying distribution cliques are discussed in further detail in connection with FIGS. 2 and 5.

In example embodiments the representative node selector 116 is operatively connected to the distribution clique identifier 114 and the data collection signal device 110. In example embodiments, the representative node selector is any hardware (e.g., circuitry), software, firmware, or any combination thereof that includes functionality to select one or more representative edge nodes from each distribution clique identified by the distribution clique identifier. In example embodiments, the representative node selector selects one or more representative edge nodes from the distribution cliques using any scheme for selecting one or more items from a larger group of such items.

As an example, the one or more edge nodes may be selected randomly, at least for the first cycle of the present ML training techniques described herein. Other techniques for selecting representative edge nodes (e.g., a round robin scheme) may be used without departing from the scope of embodiments described herein. In example embodiments, future ML model training cycles may use any technique to select different sets of one or more nodes from identified maximal cliques, which may improve training of the ML algorithm.

In example embodiments, the representative node selector 116 of the model coordinator 102 uses the distribution cliques to decide which edge node(s) will send their respective data. The representative node selector then selects a (or a single) edge node to represent its distribution clique by sending feature data to the model coordinator. Similarly, as in the collection of the probability distributions, in example embodiments mechanisms for accounting for excessive delay or unavailability of edge nodes may be defined based on the environment and the domain. An example of such a mechanism is to determine a maximum waiting time for the collection of the data from a representative edge node. If the time limit is exhausted and the feature data is not received, the representative node selector may change its selection of the representative edge node for the clique from which feature data was not received.

In example embodiments, the representative node selector 116 includes functionality to request the operatively connected data collection signal device 110 to send a feature data collection request signal to the selected edge nodes.

In example embodiments, the feature data receiver 118 is operatively connected to the representative node selector 116, and thereby has access to a listing of representative edge nodes selected from the distribution cliques. In example embodiments, the feature data receiver is any hardware (e.g., circuitry), software, firmware, or any combination thereof that includes functionality to receive feature data from the representative edge nodes. In example embodiments, feature data is received in any manner capable of collecting data from or about computing devices (e.g., via, at least in part, one or more network interfaces of the model coordinator 102).

In example embodiments, the model updater 120 is operatively connected to the feature data receiver 118 and the probability distribution receiver 112. In example embodiments, the model updater is any hardware (e.g., circuitry), software, firmware, or any combination thereof that includes functionality to use feature data received via the feature data receiver to train and validate a ML model during a training cycle. The ML model being trained and validated may be any ML model without departing from the scope of embodiments described herein, and may be intended for any relevant purpose (e.g., classification, inference, identification, storage solution sizing, and the like).

In example embodiments, the model analyzer 122 is operatively connected to the model updater 120. In example embodiments, the model analyzer is any hardware (e.g., circuitry), software, firmware, or any combination thereof that includes functionality to analyze the ML model trained by the model updater to obtain any relevant type of information. In example embodiments, one such type of information is an initial or updated list of important features.

In example embodiments, an important feature is a feature (described above) of an edge node that is particularly relevant (e.g., has an impact on the training of the ML model). In example embodiments important/relevant features are derived using the ML model training itself, for ML models that inherently provide feature importance. As an example, a random forest algorithm ML model produces a weighted ranking of features, and features having a weight over a feature importance threshold may be deemed as important features. As another example, the model analyzer 122 may use other techniques, such as Fisher Score, Importance Gain, and the like to determine a set of one or more relevant features. In example embodiments the relevant features identified by the model analyzer may be used when requesting probability distributions and/or feature data from edge nodes in future training cycles, which may further reduce the amount of data that must be prepared and transmitted by the edge nodes to facilitate ML model training in embodiments described herein.

In example embodiments, the model analyzer 122 also includes functionality to use the validation results for the ML model trained during the current training cycle to compare against the validation results from a previous cycle of ML model training. Such a comparison may determine if the ML model trained during the current cycle performs better or worse than the ML model trained during the previous cycle.

In example embodiments, the divergence threshold updater 124 is operatively connected to the model analyzer 122 and the distribution clique identifier 114. In example embodiments, the divergence threshold updater is any hardware (e.g., circuitry), software, firmware, or any combination thereof that includes functionality to update the divergence threshold value that is used for distribution clique identification. In example embodiments, the divergence threshold updater uses the results of the comparison performed by the model analyzer of the validation results of the current ML training cycle and the validation results of a previous ML model training cycle to update the divergence threshold value for use in the next ML model training cycle. In example embodiments, if the model is performing worse than the previous model, then the divergence threshold value may be reduced, thereby forcing edge nodes to be more similar in order to be determined as belonging in the same distribution clique. This similarity standard may increase the number of distribution cliques and, by extension, the number of representative nodes from which feature data is received for ML model training in the next cycle. In example embodiments, if the model is performing better than the previous model, then the divergence threshold value may be increased, thereby relaxing the similarity standard for edge nodes to be determined to belong in the same distribution clique, which may decrease the number of distribution cliques and, by extension, the number of representative nodes from which feature data is received for ML model training in the next cycle. In example embodiments, the divergence threshold updater is configured to provide updated divergence threshold values to the distribution clique identifier for use in identifying distribution cliques in the next ML model training cycle.

While FIG. 1B shows a configuration of components, other configurations may be used without departing from the scope of embodiments described herein. For example, although FIG. 1B shows all components as part of the same device, any of the components may be grouped in sets of one or more components which may exist and execute as part of any number of separate and operatively connected devices. As another example, a single component may be configured to perform all or any portion of any of the functionality performed by the components shown in FIG. 1B. Accordingly, embodiments disclosed herein should not be limited to the precise configuration of components shown in FIG. 1B.

### B.2. Data Gathering

The present divergence threshold solution leverages a protocol that is based on the following insight: it is expected that some edge nodes 104 (e.g., storage arrays) might have a different data distribution than others, but it is also expected that some edge nodes might share similar data distributions. Example embodiments leverage methods of probability distribution comparisons and efficient algorithms to select subsets of arrays from which to request data from the central model.

In example embodiments, each edge node may comprise a distinct set of computational resources. A purpose of the present data gathering method is to minimize the overhead imposed on those resources for the training of a central machine learning model. It is appreciated that some (or all) edge nodes may comprise significant computational resources-still, because these nodes have their own workloads to process, any overhead imposed by the model training process may be undesirable. In an example domain of storage arrays, it is appreciated that some may comprise reasonably large compute, memory, and network resources. Still, these resources are necessary for the own storage array's operation and should preferably not be overly requisitioned by the training process. For purposes of the present data gathering method, all that is required of the edge nodes is that they have enough resources to compute probability distributions over the data they collect.

FIG. 2 shows a flowchart of an example method 200 for determining a divergence threshold during data gathering, in accordance with illustrative embodiments. In general, in example embodiments the present data gathering protocol is composed of many cycles of data gathering, where at each cycle the present divergence threshold techniques sample a subset of the edge nodes for their data. In particular, the method represents a protocol for smart data sharing according to the similarity in node data distribution for training a central model with data from a set of edge nodes. In some implementations, the divergence threshold value ε is defined in a blind stepwise method based on the change in model metrics θ. The parameter c is a negative fraction between 0 and 1.

In example embodiments, the method 200 begins with an initial value for the divergence threshold value ε.

In example embodiments, the method 200 includes signaling the edge nodes to calculate and begin sharing their probability distribution (or a small set of distribution parameters thereof) with the central node (step 202).

In example embodiments, the method 200 includes collecting the distribution parameters from the edge nodes (step 204).

In example embodiments, the method 200 includes finding distribution cliques for the edge nodes (step 206). For example, for each received distribution, finding distribution cliques includes comparing the distributions using a bounded symmetric divergence metric (e.g., root square of the Jensen-Shannon divergence), optionally weighing these metrics by feature importance. In some embodiments, finding distribution cliques includes applying a quasi-maximal clique finding algorithm to obtain clusters of edge nodes sharing the “same” distribution (e.g., cliques), that is, distributions with a distance within the threshold ε.

In example embodiments, the method 200 includes sampling data from the edge nodes in each clique (step 208). For example, sampling data includes selecting one random element from each clique and sending a signal to the corresponding edge node to share its data.

In example embodiments, the method 200 includes training the model (step 210). For example, after the data is received, a central model is trained and kept as the new model, storing metadata for the training.

In example embodiments, the method 200 includes comparing validation metrics θ (step 212). For example, comparing model metrics can include calculating and storing the validation metric θ so as to couple θ to the next divergence threshold value E. The validation metric θ is sometimes referred to herein as model metrics, metric comparison, and quality metrics. In general, the validation metric θ represents effects of a change in divergence threshold value E.

In example embodiments, the method 200 includes updating the divergence threshold value ε(step 214). For example, updating the divergence threshold value can include obtaining εₜ₊₁=min (1, max (0, εₜ−cθ)). Advantageously, obtaining εₜ₊₁ operates to bound ε to fall between 0 and 1 so that any improvement or worsening of the validation metric θ might bring the model back to a different regime. This value εₜ₊₁ becomes the new current divergence threshold value ε.

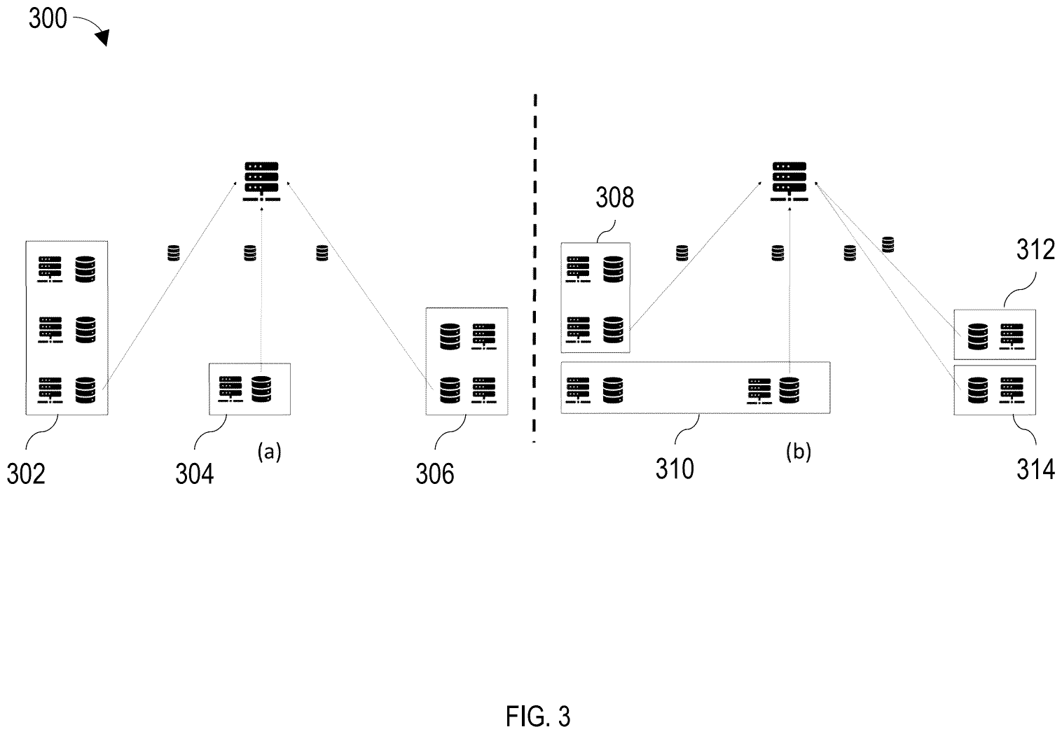

FIG. 3 shows example distribution cliques of edge nodes, in accordance with illustrative embodiments. FIG. 3 shows an example data gathering environment 300 with representative cliques 302, 304, 306, 308, 310, 312, 314 of edge nodes illustrated.

In particular, FIG. 3 shows two examples (a) and (b) of data collection from different cliques. FIG. 3 shows a central node at the top and edge nodes at the bottom. Rectangles 302, 304, 306, 308, 310, 312, 314 show edge nodes currently grouped under a given clique. One edge node (or more) from each clique is selected to share data. At a given point in time (a), given edge nodes are grouped together 302, 304, 306; and at a different point in time (b), this grouping 308, 310, 312, 314 might change if other cliques are found at another point in time.

### B.3. Divergence Threshold

The data gathering protocol discussed in section B.2. is highly dependent on the divergence threshold value ε that is used to determine the cliques of edge nodes (e.g., groups of edge nodes with similar distributions) which are then used to minimize the amount of data sent to the central node.

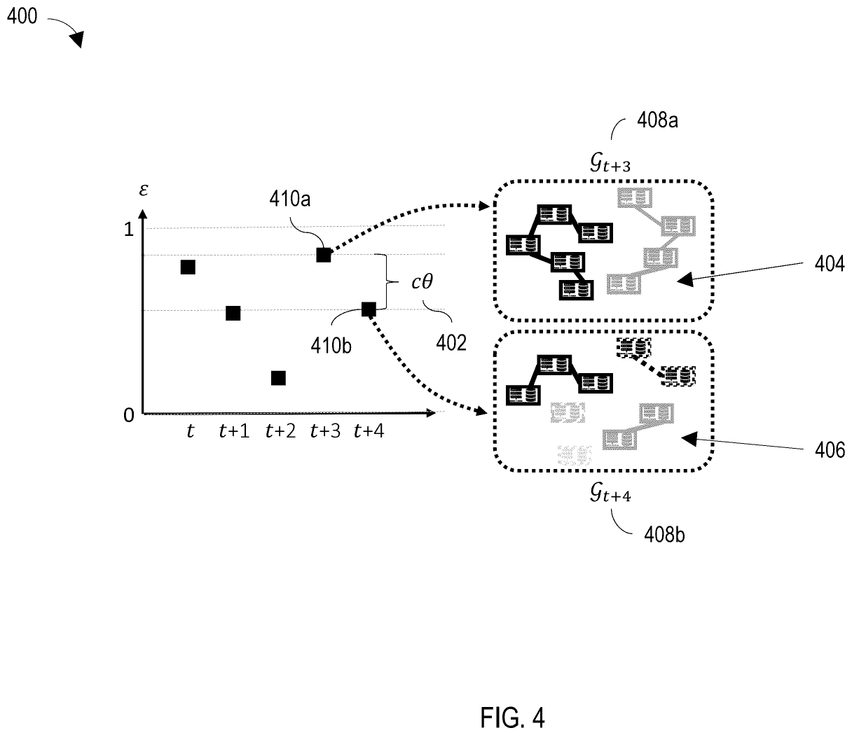

Using the data gathering protocol discussed in section B.2. sometimes results in the divergence threshold value being difficult to keep updated, since it is updated using a blind stepwise method. Accordingly in practice, the adjustment of the divergence threshold value based on the decrement of quality metrics θ of the model can be too “brittle.” FIG. 4 illustrates this divergence threshold value adjustment issue.

FIG. 4 shows example distribution cliques of edge nodes, in accordance with illustrative embodiments. In particular, FIG. 4 shows a data gathering environment 400 in which a small change 402 in the model's quality metrics θ (e.g., accuracy) causes a drastic re-definition 404, 406 of node cliques [symbol] 408a, 408b from cycle t+3 410a to cycle t+4 410b in the approach described in section B.2.

FIG. 4 shows that the update of the divergence threshold value ε is directly related to a change in metrics θ obtained from the cyclical training of the target model.

For the adopted formulation (in which ε should increase when the model quality drops, allowing for larger cliques), if θ corresponds to the drop in training loss (model quality enhancement), then the scaling argument c is assumed to be negative value between [−1, 0]. Otherwise, if θ represents a drop in model quality, then c is presumed to be a positive value between [0,1].

The absolute value of c represents a scaling factor, as discussed in sections B.1. and B.2. In practice, however, it is appreciated there is no generally applicable static value of c that allows for an appropriate change in ε under all circumstances.

Furthermore, the update of the divergence threshold value discussed in section B.2. (e.g., step 214 (FIG. 2)) does not account for available computational resources at the edge nodes in each clique. It is appreciated that the underlying correlations between the availability of resources and the data distributions at the nodes may be significant but are not trivially determined a priori.

### C. DETAILED DISCUSSION OF AN EXAMPLE EMBODIMENT

In view of the considerations discussed in section B.2., the present divergence threshold method to dynamically adjust the divergence threshold value ε based not only on the model metrics but also on the resulting cliques and availability of resources at nodes is desirable.

### C.1. Overview

Example embodiments of the present divergence threshold solution include a method to update the similarity-based divergence threshold value by modelling the problem of updating the divergence threshold value ε via a machine learning divergence model. In some embodiments, the divergence model is a policy network that includes a Deep Q-Learning reinforcement learning agent based on a graph neural network.

The terms divergence model and policy network help distinguish between that neural network and the target machine learning model that is used and trained in the data gathering discussed in section B.2. FIG. 5 shows an example overview of the present divergence threshold solution.

FIG. 5 shows a flowchart of an example method 500, in accordance with illustrative embodiments. In particular, the method introduces a secondary data gathering mechanism (e.g., steps 502, 504, 506, 508, 510, 512, 514, 516) parallel to the data gathering for the training of the target model (e.g., steps 202, 204, 206, 208, 210, 212).

The purpose of the present divergence threshold mechanism is to compose a set of episodes D for the training of the divergence model. In example embodiments, the agent is implemented as a graph neural network that receives as input a state of the environment at instant t and relates an action of a change in & to a reward r, which is determined from the improvement in the training metrics for the target model obtained in step 212.

The present divergence threshold approach operates in similar fashion to the data gathering solution described in section B.2. up to the point where the divergence model is available (e.g., step 514). From then on, the present divergence threshold approach relies on the policy network to determine εₜ₊₁ (e.g., step 516) instead of on the greedy stepwise method discussed in section B.2.

### C.2. Training Stage

During the training stage, the present divergence threshold approach is similar to the approach described in section B.2., with added data gathering steps (e.g., steps 502, 504, 506, 508, 510). In example embodiments, the data sampling from the edge node cliques remains generally the same as in the approach discussed in further detail in section B.2., as is the update of the divergence threshold. Upon determining that enough episodes have been composed, the present divergence threshold solution triggers the policy network training (step 514).

### C.2.1. Data Gathering

In example embodiments, the general purpose of the data gathering is to obtain episodes for the training of a reinforcement learning-based agent. The present data gathering stage may last for several cycles of the approach discussed in section B.2. The cycles of the approach discussed in section B.2. are timestamp from t=1 and incrementally.

At step 204 in the cycle the central node collects the distribution parameters from the nodes, as in the approach discussed in section B.2. Example embodiments of the present divergence threshold solution extend that data gathering to additionally store that data in a datastore [symbol] at the central node (step 502). In some embodiments, the datastore can be a central database accessible by the central node.

At each step 206, similarly, in some embodiments the central node applies a quasi-maximal clique finding algorithm to obtain clusters of edge nodes sharing the “same” distribution (e.g. cliques), that is, distributions with a distance—considering the current bounded symmetric divergence metric—within the divergence threshold value εₜ. Example embodiments of the present divergence threshold solution extend that data gathering to additionally store those cliques in [symbol] (step 504).

At step 208, example embodiments of the central node sample data from the edge node cliques according to a predetermined strategy. In one embodiment, as described in section B.2., this data sampling comprises a random sampling of a single random node from the clique. More generally, in example embodiments a function S(C,p)→I determines the indexes I={i, . . . } corresponding to the indexes of the nodes Nᵢ ∈C.

The present divergence threshold solution extends that data gathering to additionally obtain information on the resource availability and utilization status from the selected edge nodes (step 508). In example embodiments, the central node queries each edge node Nᵢ, i ∈I for relevant resource information. In some embodiments these resources may comprise available storage, aggregate statistics of the workloads being processed at the node, or the availability of specific computational resources such as CPU cores and GPUs.

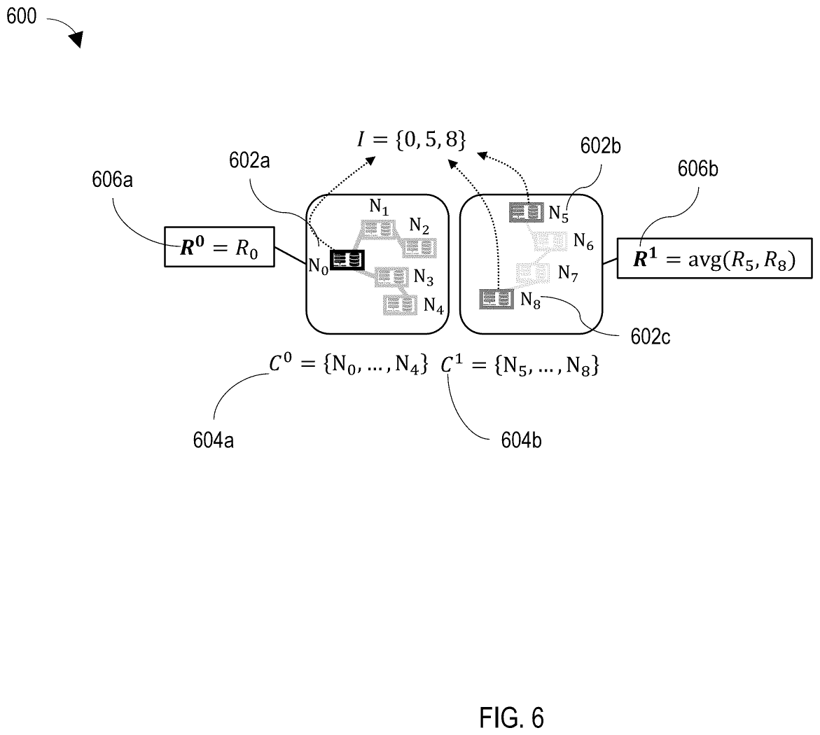

FIG. 6 shows an example data gathering environment 600 from edge nodes, in accordance with illustrative embodiments. In particular, in example embodiments each selected edge node Nᵢ 602a, 602b, 602c for data sampling from a clique C^{j} 604a, 604b is also queried for its resource status Rᵢ 606a, 606b. The aggregate (average, in the example shown in FIG. 6) of these resources R^{j} is associated with the corresponding clique.

In example embodiments the resource status data R^{j} 606a, 606b obtained from the querying is associated with each clique C^{j} 604a, 604b in Gt. As shown in FIG. 6 for resource status R° 606a, in the degenerate case in which a single edge node Nᵢ from a clique is selected, such as node No 602a, the present divergence threshold solution associates its resources Rᵢ with the clique C^{j} directly (e.g., R^{j}=Rᵢ, in particular R⁰=R₀ as shown in FIG. 6).

In example embodiments, if more than one node from a single clique is sampled, as FIG. 6 shows in connection with the resource status R¹ 606b, an aggregate of those resources is associated instead (in the example of FIG. 6, the average of the metrics queried). For example, FIG. 6 shows that the resource status R¹ includes an aggregate (e.g., average) of the resource status R₅, R₈ from the edge nodes N₅, N₈ 602b, 602c, respectively.

In example embodiments, these resources R 606a, 606b associated with the cliques will comprise parts of the input for the divergence model, both in training episodes (e.g., step 514) as well as during inferencing (e.g., step 516).

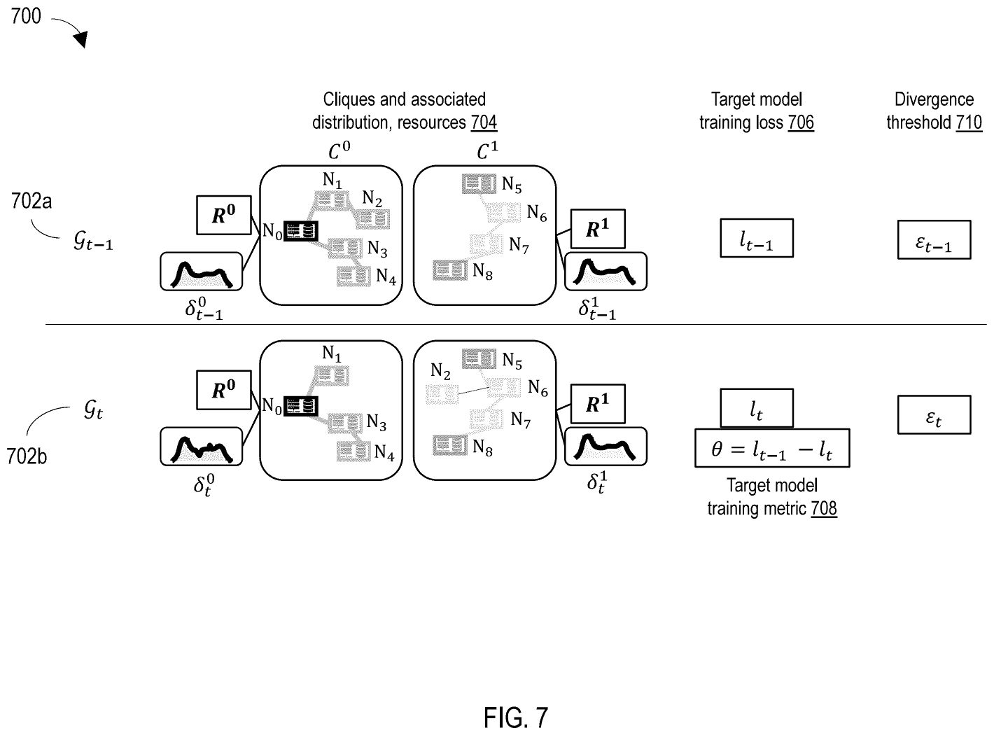

FIG. 7 shows an example data gathering environment 700 in operation for multiple cycles t, t+1, . . . , in accordance with illustrative embodiments. In particular, FIG. 7 depicts the data [symbol] including the graphs [symbol] 702a, 702b with the cliques, associated distribution, and resources 704 gathered over multiple cycles in order to update a given divergence threshold value 710.

In example embodiments, the episodes for the training of the divergence model are defined with respect to D. It is appreciated that the target model training metrics θ 708 depend on the training results 706 of a previous cycle.

It is further appreciated that in the illustrated example although the cliques 704 change, the number of cliques remains the same. For example, FIG. 7 shows that the composition of the cliques C⁰ and C¹ change, but there remain two cliques, C⁰ and C¹, in the illustrated example. Particularly, at time t−1, the clique C⁰ includes the node N₂, while at time t, the node N₂ has been included in the clique C¹.

However, advantageously the present divergence threshold approach also allows for the number of cliques to change from one cycle to the next. This flexibility in terms of numbers of cliques is why example embodiments of the present divergence threshold solution compose episodes considering each clique separately. This episode composition is described in further detail in section C.2.2.

### C.2.2. Episode Composition

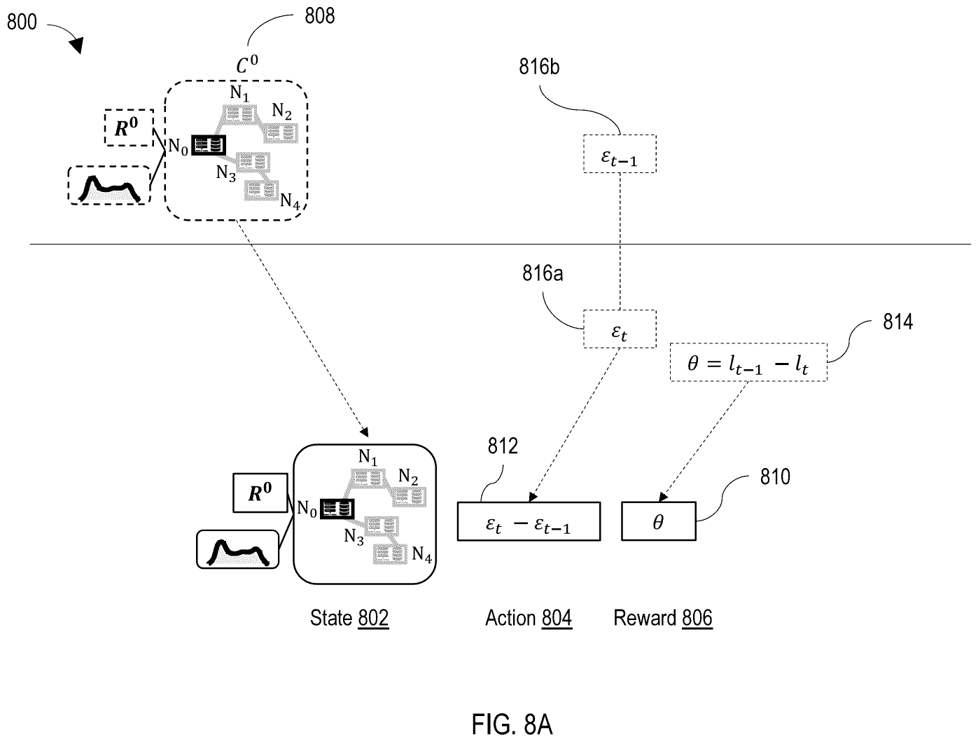

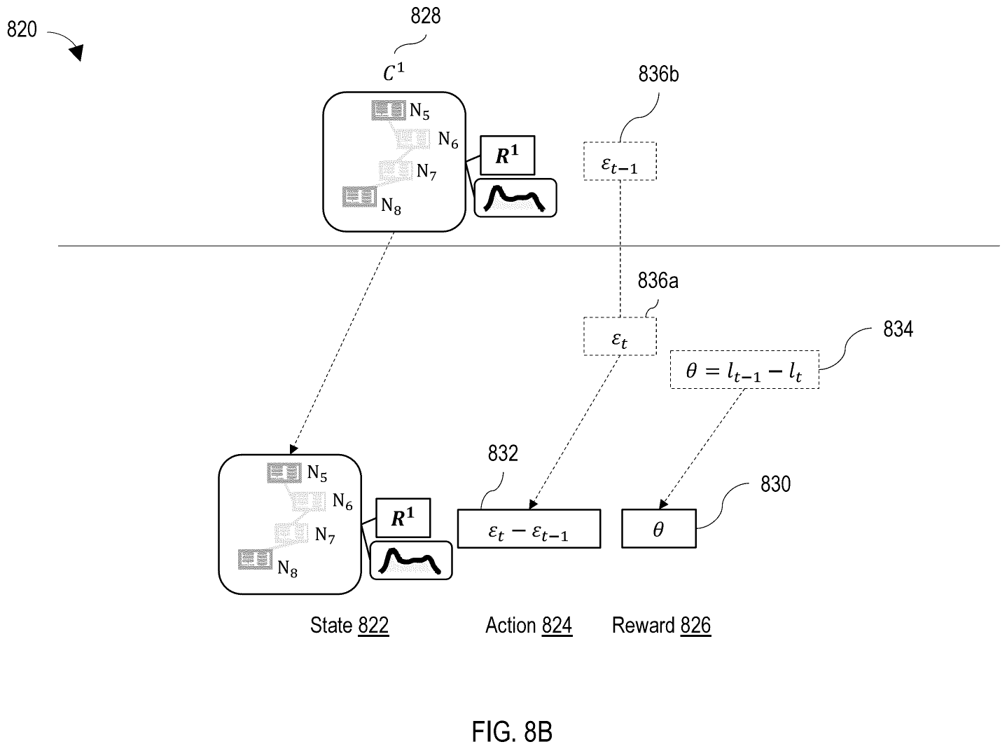

FIG. 8A shows an example episode composition 800, in accordance with illustrative embodiments. The episodes are the samples for the training of the divergence model (e.g., step 514). Example embodiments of each episode include:
The state 802, for example:
   a clique from the previous timestamp 808
   its associated resources, and
   its distribution parameters
The action 804, for example:
   a difference 812 between the current divergence threshold value εₜ 816a, and the divergence threshold value at the previous timestamp εₜ₋₁ 816b, and
The reward 806, for example:
   derived from the metrics θ 810 in the model training and model comparison steps (e.g., steps 210, 212, respectively). In example embodiments the reward corresponds with the increase in training loss θ 814 obtained by the model.

In particular, FIG. 8A shows an example episode 800 composed from [symbol] , relating the characteristics of the clique C° 808 at timestamp t−1 to the effects (θ) 810 of a change 812 in the divergence threshold ε from t−1 to t.

As mentioned, it is appreciated that in FIG. 8A, the cliques at timestamp t are not used. Instead, example embodiments of the present divergence threshold solution relate the characteristics of a clique 802 and a change in the divergence threshold value 804 to a future change in the target model's metrics 806. Advantageously, this flexibility demonstrates why the present divergence model is resilient to changes in the cliques caused by the change in distributions at the nodes (and by the change in the divergence threshold value, as well).

In example embodiments, the present divergence threshold approach includes singling out each clique 808 from a timestamp t−1 as the ‘state’ 802 for a distinct episode 800. Each clique thus generates a different state representation and thus a distinct episode. Seeing as the necessary number of episodes for training of the divergence model may be large, the present divergence threshold approach also helps with generating sufficient episodes for the policy network training faster.

FIG. 8B shows an example episode 820 composed for the same timestamp t as in FIG. 8A, in accordance with illustrative embodiments. In particular, FIG. 8B illustrates an example episode composition for the clique C¹ 828 from [symbol] at the same timestamp t. In example embodiments, the episode 820 includes a state 822, an action 824, and a reward 826.

In example embodiments, the episode 820 relates the characteristics of the clique 822 and a change in the divergence threshold value 824 to a future change in the target model's metrics 826.

Example embodiments of the state 822 include the characteristics of the clique C¹ 828.

Example embodiments of the action 824 include the change 832 in the divergence threshold value 836a, 836b.

Example embodiments of the reward 826 include determining a future change 830 in the target model's metrics 834. In some embodiments, the reward can be further incremented with external information, such as a function to penalize cliques that are too small (typically corresponding to too many cliques). The reward should preferably be the same for all episodes 800 composed in this cycle t.

### C.2.3. Divergence Model Training

In some embodiments, the divergence model includes a policy network that is trained with the episodes comprising the training dataset.

### C.2.3.1. Bootstrapping

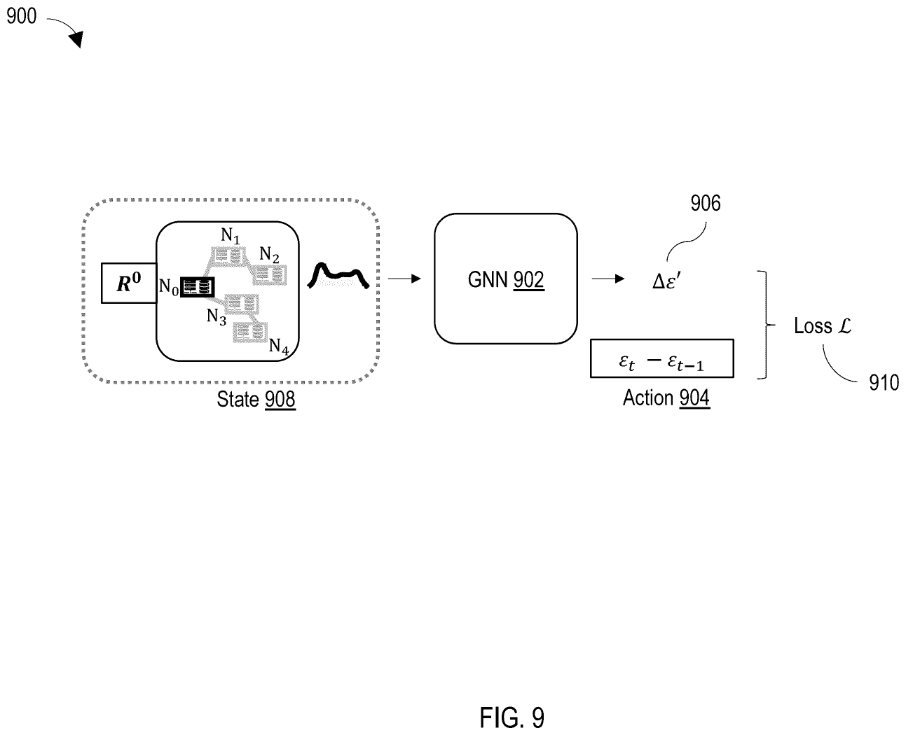

FIG. 9 shows example bootstrapping 900 during a training stage, in accordance with illustrative embodiments. Example embodiments of the present divergence threshold solution leverage the collected episodes (as described in section C.2.2.) for bootstrapping the network. In some embodiments, during bootstrapping the present divergence threshold solution trains the divergence model to approximate the actions 904 of the stepwise update of the divergence threshold value. In particular, FIG. 9 shows a bootstrap training 900 of the divergence model as a graph neural network 902 from a single episode.

Example embodiments of the divergence model include a policy network that can use a graph neural network (GNN) 902. Advantageously, this design allows different cliques (e.g., of distinct sizes and configurations) to be straightforwardly treated as input (e.g., a graph). In example embodiments, the resources and distribution parameters associated with the clique (e.g., part of the state 908) can be attributes annotated to the nodes of the graph.

In alternate embodiments, a form of encoding of the cliques into a fixed-length input may be devised. In that case, other types of neural network architectures may be employed. The present disclosure proceeds presuming that a GNN is used, for ease of the following discussion.

After a sufficient number of episodes, which may comprise the full set of available episodes, the bootstrapping of the network should cause it to approximate the changes in & 906 actually observed in previous cycles of the distributed data gathering protocol.

In example embodiments, the present divergence threshold solution proceeds to further train the network in order to allow it to generalize. In some embodiments, this further training may be done directly after the deployment of the model. In other embodiments, an intermediate bootstrapping step helps to generalize the policy network based on the available episodes.

### C.2.3.2. Intermediate Bootstrapping

In example embodiments the intermediate bootstrapping discussed in this section is an optional stage. In other embodiments after the bootstrapping discussed in section C.2.3.1., the present divergence threshold solution may proceed with training the divergence model with a change to the loss value computation 910, seeking to allow greater generalization. In particular, the graph neural network 902 is trained with an episode state 908 as input and outputting 904 a value of change to the divergence threshold 906. The loss 910 for the training is determined by the observed changes in the target model's metrics θ.

The intuition is as follows.

Notice that the contemplated scenario is still restricted to episodes in which the actions and reward were obtained prior to the deployment of the divergence model. That is, there are no episodes available yet in which the actions 904 (e.g., the adjustment of the divergence metric) are determined by the divergence model, and therefore no matching rewards (the increase in model quality metrics) to those actions. Still, it is appreciated that the results of the divergence model should be generalizable beyond matching the stepwise adjustment as discussed in section C.2.3.1.).

The present intermediate bootstrapping employs a mechanism that allows a form of ‘experience replay,’ even though that experience was not generated by the performance of the agent.

The process is as follows, performed as necessary (see below) and as data is available in D:
1) Compose a batch of input samples, from the episode states 908 available in D.
2) For each sample in the batch,
   a) Obtain the corresponding output 906 of the divergence model 902 Δε′
   b) Compute a difference between the output of the network Δε′ 906 and the episode's action 904 (e.g., the actually observed εₜ−εₜ−1)
   c) Determine a loss value 910 based on the episode's reward θ, scaled by that difference.
3) Adapt the model to minimize the average loss of the batches.

In the first training epoch(s) the output of the divergence model and the episode's action should roughly match (since the divergence model was first trained to mimic the actual divergence threshold heuristic). From then on, however, the divergence model should learn to prioritize actions estimated to improve the quality of the target model, “trusting” its own assessment relative to how much it deviates from the observed actions.

It is further appreciated that the present intermediate bootstrapping should not be allowed to proceed for too long, as it risks detaching the divergence model from the stepwise approach too abruptly at first. In some embodiments the present bootstrapping generalization should track the similarity of the divergence model outputs to the episodes' actions (step 2.b.) and halt after a batch (or sequence of batches) yields values too different in average.

Thus, the present intermediate bootstrapping operates to balance the need for the divergence model to generalize its choice of actions (e.g., its outputs) while also staying representative of the actual changes observed in the domain.

### C.3. Deployment Stage

In example embodiments, after the trained divergence model is obtained, either with or without the intermediate bootstrapping generalization process, the divergence model can then be deployed and used for determination of the divergence threshold value from then on (e.g., step 516 (FIG. 5)). Updating the divergence threshold value is further discussed in section C.3.1.

With reference to FIG. 5, in example embodiments the present divergence threshold solution marks the timestamp z of deployment of the policy network (e.g., following step 514). The episode dataset [symbol] _{z} is used as reference, such that when further cycles are performed, a new training of the policy network is triggered (e.g., step 514). This continuous adaptation and retraining is further discussed in section C.3.2.

### C.3.1. Divergence Threshold Updating

In example embodiments, the determination of a new divergence threshold εₜ₊₁ at cycle t is given by the average estimate of the divergence metric Δε′ obtained from considering each current clique c as input to the policy network:

$${ε}_{t + 1} = \frac{1}{\vert C \vert} {\sum }_{c ∈ C} {Δ}_{c} {ε}^{′}$$

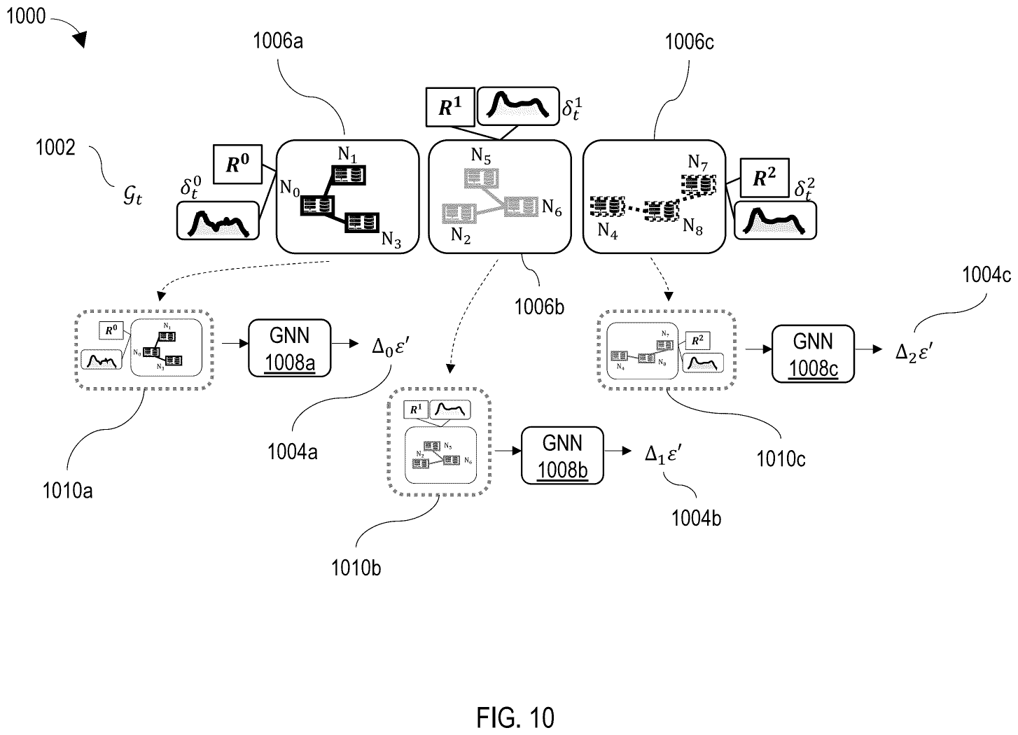

FIG. 10 shows an example data gathering environment 1000 during a deployment stage, in accordance with illustrative embodiments. Particularly, FIG. 10 shows three cliques 1006a, 1006b, 1006c that are determined at timestamp t 1002.

FIG. 10 shows an example determination 1000 of the divergence threshold value εₜ₊₁ from the current cliques 1006a, 1006b, 1006c and associated data provided as input 1010a, 1010b, 1010c to the divergence model 1008a, 1008b, 1008c. For example, the divergence threshold value εₜ₊₁ can be determined using the equation above along with the Δ₀ε′, Δ₁ε′, Δ₂ε′ 1004a, 1004b, 1004c that are determined by the divergence models, to yield:

$${ε}_{t + 1} = \frac{{Δ}_{0} {ε}^{′} + {Δ}_{1} {ε}^{′} + {Δ}_{2} {ε}^{′}}{2}$$

It is appreciated that in the present formulation, the determination of the divergence threshold value does not depend on its previous value, but rather on the configuration of the cliques 1006a, 1006b, 1006c along with the associated resource status and parameter distributions 1010a, 1010b, 1010c from the sampled nodes.

It is further appreciated that FIG. 10 illustrates that the present divergence threshold approach is capable of dealing with changes in number of cliques, and not merely changes in their configuration and associated data.

### C.3.2. Divergence Model Retraining

In example embodiments, it is appreciated that after the divergence model is deployed, the values of 0 that are ultimately obtained (e.g., at step 212 (FIG. 5)) are directly related to its actuation.

Thus, as the present process for composing the episodes (e.g., steps 502, 504, 506, 508, 510) continues to be performed, the present process now composes episodes for the adaptation of the policy network.

With reference to FIG. 5, recall from the depicted process that example embodiments of the present divergence threshold solution check whether the number of episodes composed at timestamp t is sufficiently larger (based on a predetermined threshold k) (e.g., step 512) than the episodes previously available at the timestamp z (of last deployment of the policy network).

In example embodiments, when this adaptation process is triggered, the present divergence threshold solution performs the training as follows:
1. Compose a batch of input samples, from the episode states available in [symbol] .
2. For each sample in the batch, determine a loss value based on the episode's reward θ
3. Adapt the divergence model so as to minimize the average loss of the batches.

It is appreciated that the above training process is similar to the training process discussed in section C.2.3.2., except that no restraints are imposed to ensure that the outputs of the divergence model should match those collected from the episodes.

### D. EXAMPLE METHODS

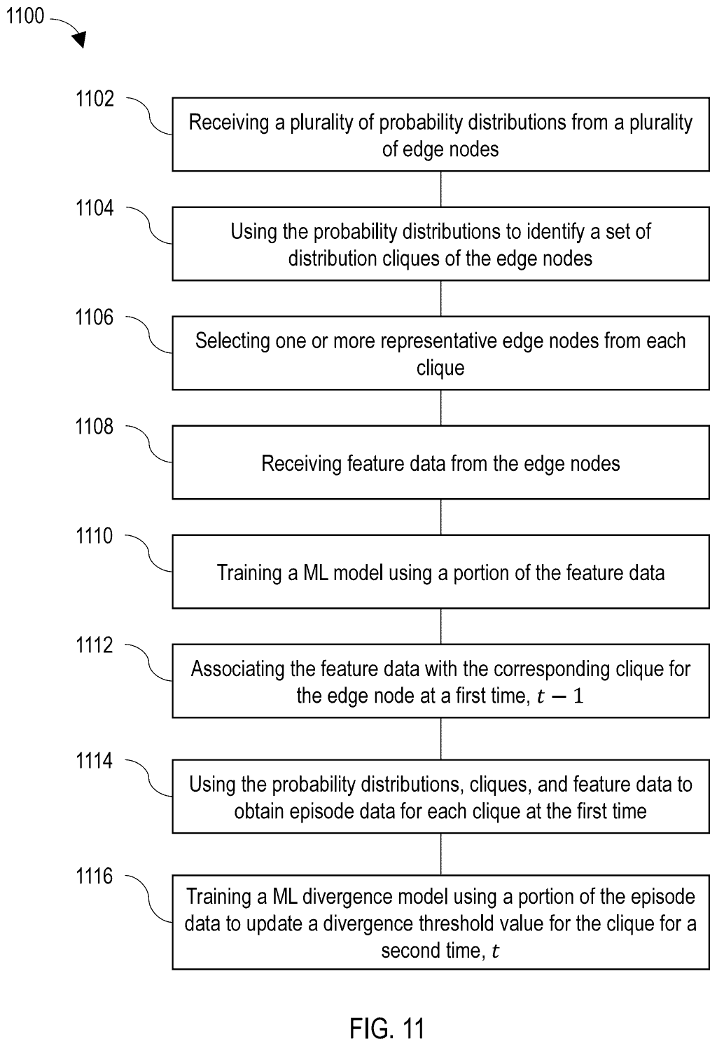

FIG. 11 shows a flowchart of an example method 1100, in accordance with illustrative embodiments. In example embodiments, the method allows for updating a divergence threshold value.

In some embodiments, the method 1100 can be performed by the model coordinator 102 (FIGS. 1A, 1B).

In example embodiments, the method 1100 includes receiving a plurality of probability distributions from a plurality of edge nodes (step 1102). By way of example and not limitation, the edge nodes can include storage arrays.

In example embodiments, the method 1100 includes using the probability distributions to identify a set of distribution cliques of the edge nodes (step 1104). In some embodiments, a number of cliques is updated for a future training cycle of the ML target model. Phrased differently, in some embodiments the number of cliques can vary between training cycles. In some embodiments, the cliques are identified using an identification algorithm. For example, the identification algorithm can include calculating a divergence value between two edge nodes of the plurality of edge nodes, comparing the divergence value with the divergence threshold value to obtain a result, and using the result to determine that the two edge nodes are in a clique.

In example embodiments, the method 1100 includes selecting one or more representative edge nodes from each clique (step 1106). In some embodiments, the representative edge nodes are selected at random from each clique.

In example embodiments, the method 1100 includes receiving feature data from the edge nodes (step 1108). For example, the feature data can include resource information that includes a resource availability and a utilization status of the edge node at a first time, t−1. In some embodiments, the feature data can be persisted in a datastore. In further embodiments, the datastore can be a central database.

In example embodiments, the method 1100 includes training a ML-based model using a portion of the feature data (step 1110).

In example embodiments, the method 1100 includes associating the feature data with the corresponding clique for the edge node at the first time, t−1 (step 1112).

In example embodiments, the method 1100 includes using the probability distributions, cliques, and feature data to train episode data for each clique for the first time, t−1 (step 1114). In some embodiments, the episode data for a second time, t, is obtained without considering the clique for the second time. Phrased differently, in some embodiments only the clique for the first time, t−1, is used as input to train the episode data for the current timestamp, t, and the clique for the current timestamp is not used.

In example embodiments, the method 1100 includes training a ML-based divergence model using a portion of the episode data to update a divergence threshold value for the clique for a second time, t, that is different from the first time, t−1 (step 1116). In some embodiments, the divergence threshold value is updated based on an average of divergence metrics output by the divergence model after the divergence model is deployed in an edge network that includes the plurality of edge nodes. In some embodiments, the divergence model is a policy network. For example, the policy network can include a deep Q-learning reinforcement learning model. In further embodiments, the reinforcement learning model is trained using a graph neural network. In yet further embodiments, the cliques include graphs, the probability distributions and the feature data include metadata annotated to nodes of the graphs, and the annotated graphs are used as input to the graph neural network.

It is noted with respect to the disclosed methods, including the example methods of FIGS. 1A-11, and the disclosed algorithms, that any operation(s) of any of these methods and algorithms, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. EXAMPLE COMPUTING DEVICES AND ASSOCIATED MEDIA

As mentioned, at least portions of the present divergence threshold solution can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present divergence threshold solution. For example, containers can be used to implement respective processing devices providing compute and/or storage services of a cloud-based system. Again, containers may be used in combination with other virtualization infrastructure such as virtual machines implemented using a hypervisor.

Illustrative embodiments of processing platforms will now be described in greater detail with reference to FIG. 12. Although described in the context of the present divergence threshold solution, these platforms may also be used to implement at least portions of other information processing systems in other embodiments.

FIG. 12 shows an example computing entity 1200, in accordance with example embodiments. The computer is shown in the form of a general-purpose computing device. Components of the computer may include, but are not limited to, one or more processors or processing units 1202, a memory 1204, a network interface 1206, and a bus 1216 that communicatively couples various system components including the system memory and the network interface to the processor.

The bus 1216 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1200 typically includes a variety of computer-readable media. Such media may be any available media that is accessible by the computer system, and such media includes both volatile and non-volatile media, removable and non-removable media.

The memory 1204 may include computer system readable media in the form of volatile memory, such as random-access memory (RAM) and/or cache memory. The computer system may further include other removable/non-removable, volatile/non-volatile computer system storage media. By way of example only, the storage system 1210 may be provided for reading from and writing to a non-removable, non-volatile magnetic media (not shown and typically called a “hard drive”) in accordance with the present divergence threshold techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 1216 by one or more data media interfaces. As has been depicted and described above in connection with FIGS. 1A-11, the memory may include at least one computer program product having a set (e.g., at least one) of program modules that are configured to carry out the functions of the embodiments as described herein.

The computer 1200 may also include a program/utility, having a set (at least one) of program modules, which may be stored in the memory 1204 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 1200 may also communicate with one or more external devices 1212 such as a keyboard, a pointing device, a display 1214, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 1208. Still yet, the computer system may communicate with one or more networks such as a local area network (LAN), a general wide area network (WAN), and/or a public network (e.g., the Internet) via the network adapter 1208. As depicted, the network adapter communicates with the other components of the computer system via the bus 1216. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

### F. CONCLUSION

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1A-12, any component described with regard to a figure, in various embodiments of the invention, may be equivalent to one or more like-named components described with regard to any other figure. For brevity, descriptions of these components have not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
at least one processing device including a processor coupled to a memory;
the at least one processing device being configured to implement the following steps:
receiving a plurality of probability distributions from a plurality of edge nodes;
using the probability distributions to identify a set of distribution cliques of the edge nodes;
selecting one or more representative edge nodes from each clique;
receiving feature data from the edge nodes, the feature data comprising resource information that includes a resource availability and a utilization status of the edge node at a first time t−1;
training a machine learning (ML)-based model using a portion of the feature data;
associating the feature data with the corresponding clique for the edge node at the first time;
using the probability distributions, cliques, and feature data to obtain episode data for each clique for the first time; and
training a ML-based divergence model using a portion of the episode data to update a divergence threshold value for the clique for a second time, t, that is different from the first time.

2. The system of claim 1, wherein the divergence threshold value is updated based on an average of divergence metrics output by the divergence model after the divergence model is deployed in an edge network that includes the plurality of edge nodes.

3. The system of claim 1, wherein a number of cliques is updated for a future training cycle of the ML model.

4. The system of claim 1, wherein the divergence model comprises a deep Q-learning reinforcement learning model.

5. The system of claim 4, wherein the reinforcement learning model is trained using a graph neural network.

6. The system of claim 5, wherein the cliques comprise graphs, the probability distributions and the feature data comprise metadata annotated to nodes of the graphs, and the annotated graphs are used as input to the graph neural network.

7. The system of claim 1, wherein the episode data for the second time, t, is obtained without considering the clique for the second time.

8. The system of claim 1, wherein the representative edge nodes are selected at random from each clique.

9. The system of claim 1, wherein the cliques are identified using an identification algorithm comprising:
calculating a divergence value between two edge nodes of the plurality of edge nodes;
comparing the divergence value with the divergence threshold value to obtain a result; and
using the result to determine that the two edge nodes are in a clique.

10. A method comprising:
receiving a plurality of probability distributions from a plurality of edge nodes;
using the probability distributions to identify a set of distribution cliques of the edge nodes;
selecting one or more representative edge nodes from each clique;
receiving feature data from the edge nodes, the feature data comprising resource information that includes a resource availability and a utilization status of the edge node at a first time t−1;
training a machine learning (ML)-based model using a portion of the feature data;
associating the feature data with the corresponding clique for the edge node at the first time;
using the probability distributions, cliques, and feature data to obtain episode data for each clique for the first time; and
training a ML-based divergence model using a portion of the episode data to update a divergence threshold value for the clique for a second time, t, that is different from the first time.

11. The method of claim 10, wherein the divergence threshold value is updated based on an average of divergence metrics output by the divergence model after the divergence model is deployed in an edge network that includes the plurality of edge nodes.

12. The method of claim 10, wherein a number of cliques is updated for a future training cycle of the ML model.

13. The method of claim 10, wherein the divergence model comprises a deep Q-learning reinforcement learning model.

14. The method of claim 13, wherein the reinforcement learning model is trained using a graph neural network.

15. The method of claim 14, wherein the cliques comprise graphs, the probability distributions and the feature data comprise metadata annotated to nodes of the graphs, and the annotated graphs are used as input to the graph neural network.

16. The method of claim 10, wherein the episode data for the second time, t, is obtained without considering the clique for the second time.

17. The method of claim 10, wherein the representative edge nodes are selected at random from each clique.

18. The method of claim 10, wherein the cliques are identified using an identification algorithm comprising:
calculating a divergence value between two edge nodes of the plurality of edge nodes;
comparing the divergence value with the divergence threshold value to obtain a result; and
using the result to determine that the two edge nodes are in a clique.

19. A non-transitory processor-readable storage medium having stored thereon program code of one or more software programs, wherein the program code when executed by at least one processing device causes the at least one processing device to perform the following steps:
receiving a plurality of probability distributions from a plurality of edge nodes;
using the probability distributions to identify a set of distribution cliques of the edge nodes;
selecting one or more representative edge nodes from each clique;
receiving feature data from the edge nodes, the feature data comprising resource information that includes a resource availability and a utilization status of the edge node at a first time t−1;
training a machine learning (ML)-based model using a portion of the feature data;
associating the feature data with the corresponding clique for the edge node at the first time;
using the probability distributions, cliques, and feature data to obtain episode data for each clique for the first time; and
training a ML-based divergence model using a portion of the episode data to update a divergence threshold value for the clique for a second time, t, that is different from the first time.

20. The storage medium of claim 19,
wherein the divergence model comprises a deep Q-learning reinforcement learning model,
wherein the reinforcement learning model is trained using a graph neural network, and
wherein the cliques comprise graphs, the probability distributions and the feature data comprise metadata annotated to nodes of the graphs, and the annotated graphs are used as input to the graph neural network.
